(19) United States
(12) Patent Application Publication
(10) Pub. No.: US 2014/0168112 A1
(43) Pub. Date: Jun. 19, 2014

(54) TOUCH SENSING METHOD AND TOUCH SENSING APPARATUS

(71) Applicant: SAMSUNG ELECTRO-MECHANICS CO., LTD., Suwon (KR)

(72) Inventors: Ji Hoon KIM, Suwon (KR); Yoon Seok Oh, Suwon (KR); Sang Hyun Sim, Suwon (KR); Hyun Suk Lee, Suwon (KR)

(73) Assignee: SAMSUNG ELECTRO-MECHANICS CO., LTD., Suwon (KR)

(21) Appl. No.: 13/904,685

(22) Filed: May 29, 2013

(30) Foreign Application Priority Data
Dec. 18, 2012 (KR) 10-2012-0148513

(51) Int. Cl. G06F 3/041

(52) U.S. Cl. CPC G06F 3/0418
USPC 345/173

(57) ABSTRACT

There are provided a touch sensing apparatus and a touch sensing method. The touch sensing method includes: obtaining sensed data from a touchscreen and a touch key;

determining whether a touch has been applied to the touch key; and when it is determined that a touch has been applied to the touch key, whether to apply one or more noise canceling algorithms is determined based on the sensed data obtained from the touchscreen.

### CROSS-REFERENCE TO RELATED APPLICATIONS

This application claims the priority of Korean Patent Application No. 10-2012-0148513 filed on Dec. 18, 2012, in the Korean Intellectual Property Office, the disclosure of which is incorporated herein by reference.

### BACKGROUND OF THE INVENTION

1. Field of the Invention

The present invention relates to a touch sensing method and a touch sensing apparatus in which, when a touch is applied to a touch key, first, it is presumed that a touch has not been applied to a touchscreen, and whether to apply a noise canceling algorithm is determined based on sensed data obtained from the touchscreen.

2. Description of the Related Art

A touch sensing apparatus such as a touchscreen, a touch pad, or the like, is an input device attached to a display device to provide an intuitive data input method to a user. Recently, a touch sensing apparatus has been widely applied to various electronic devices such as cellular phones, personal digital assistants (PDAs), navigation devices, and the like. In particular, recently, as demand for smartphones has increased, a rate of touchscreen employment as touch sensing apparatuses capable of providing various input methods in a limited area is on the rise.

Touchscreens employed in portable devices may be classified as resistive-type touchscreens and capacitive-type touchscreens according to a method of sensing a touch utilized thereby. Among these, capacitive touchscreens, having advantages in terms of relatively long lifespans and various easily implementable data input methods, have been increasingly applied. In particular, the capacitive touchscreen, facilitating the implementation of a multi-touch interface relative to the resistive touchscreen, is extensively employed in devices such as smartphones, and the like.

The capacitive touchscreen includes a plurality of electrodes having a predetermined pattern, and a plurality of nodes in which capacitance is changed by a touch are defined by the plurality of electrodes. The plurality of nodes distributed on a two-dimensional (2D) plane generate changes in self-capacitance or in mutual-capacitance according to a touch applied thereto, and coordinates of a touch may be calculated by applying a weighted average calculation method, or the like, to the change in capacitance generated in the plurality of nodes. In order to accurately calculate coordinates of a touch, it is necessary to discriminate noise that may be introduced to the touchscreen from sensed data generated by an actual touch. In particular, in mobile devices such as smartphones, tablet PCs, or the like, a display, an RF module, and the like, are integrated into a small hardware package, so noise introduced to the touchscreen may be generated from various factors.

Cited document 1 relates to a touch sensing apparatus and method for preventing malfunctioning, or the like. In this document, a counter value is increased while a touch is continued, and when noise is determined to be present, the increasing of the counter value is stopped, thereby discriminating a touch from noise. However, cited document 1 does not disclose a configuration in which, when sensed data is obtained from a touch key, first, it is presumed that a touch has not been applied to a touchscreen and a noise canceling algorithm is executed based on sensed data obtained from the touchscreen.

### RELATED ART DOCUMENT

(Patent document 1) Korean Patent Laid Open Publication No. 10-2009-0070605

### SUMMARY OF THE INVENTION

An aspect of the present invention provides a touch sensing method and a touch sensing apparatus in which, when it is determined that an input has been applied to a touch key, first, it is presumed that an input has not been applied to a touchscreen and whether to apply one or more noise canceling algorithms is determined based on sensed data obtained from the touchscreen, thus accurately determining whether noise has been generated.

According to an aspect of the present invention, there is provided a touch sensing method including: obtaining sensed data from a touchscreen and a touch key; determining whether a touch has been applied to the touch key; and when it is determined that a touch has been applied to the touch key, whether to apply one or more noise canceling algorithms is determined based on the sensed data obtained from the touchscreen.

The method may further include: when it is determined that a touch input has been applied to the touch key, presuming that a touch input has not been applied to the touchscreen.

In the determining whether to apply one or more algorithms, when it is determined that touches have been applied to both the touch key and the touchscreen, the one or more noise canceling algorithms may be applied.

In the determining whether to apply one or more algorithms, when it is presumed that a touch has only been applied to the touchscreen, the one or more noise canceling algorithms may be applied based on noise included in sensed data obtained from the touchscreen.

In the determining whether to apply one or more algorithms, when it is determined that a touch has only been applied to the touch key, noise of each sensing channel of the touchscreen may be evaluated and the one or more noise canceling algorithms may be applied.

In the determining whether to apply one or more algorithms, at least one of a noise avoidance algorithm, a reference sensed data resetting algorithm, a touchscreen recalibration algorithm, an algorithm for altering driving signal characteristics with respect to a plurality of electrodes, and a sensed data filtering algorithm may be applied as the one or more noise canceling algorithms.

According to another aspect of the present invention, there is provided a touch sensing apparatus including: one or more touch keys; a touchscreen including a plurality of electrodes; and a controller obtaining sensed data from the one or more touch keys and the touchscreen and determining a touch, wherein one or more noise canceling algorithms are applied based on whether a touch has been applied to the one or more touch keys and sensed data obtained from the touchscreen.

When it is determined that a touch has been applied to the one or more touch keys, it may be presumed that a touch has not been applied to the touchscreen.

When it is determined that touches have been applied to both the one or more touch keys and the touchscreen, the controller may apply the one or more noise canceling algorithms.

When it is determined that a touch has only been applied to the one or more touch keys, the controller may evaluate noise of each of a plurality of sensing channels connected to the plurality of electrodes, respectively, and apply the one or more noise canceling algorithms.

When it is determined that a touch has only been applied to the touchscreen, the controller may apply the one or more noise canceling algorithms based on noise included in sensed data obtained from the touchscreen.

The one or more noise canceling algorithms may include at least one of a noise avoidance algorithm, a reference sensed data resetting algorithm, a touchscreen recalibration algorithm, an algorithm for altering driving signal characteristics with respect to a plurality of electrodes, and a sensed data filtering algorithm.

According to another aspect of the present invention, there is provided a touch sensing apparatus including: a sensing circuit unit obtaining sensed data from a touch key and a touchscreen; and a calculating unit determining a touch based on the sensed data, wherein when it is determined that a touch has been applied to the touch key, the calculating unit presumes that a touch input has not been applied to the touchscreen, and determines whether to apply one or more noise canceling algorithms based on the obtained sensed data.

When it is determined that a touch has been applied to the touchscreen based on sensed data obtained from the touchscreen, the calculating unit may apply the one or more noise canceling algorithms.

When it is determined that a touch has not been applied to the touchscreen based on sensed data obtained from the touchscreen, the calculating unit may determine whether to apply the one or more noise canceling algorithms based on a noise component included in the sensed data obtained from the touchscreen.

When it is determined that a touch has not been applied to the touch key, the calculating unit may determine whether to apply the one or more noise canceling algorithms based on a noise component included in the sensed data obtained from the touchscreen.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the exterior of an electronic device including a touch sensing apparatus according to an embodiment of the present invention;

FIG. 2 is a view illustrating a touchscreen panel unit that may be included in the touch sensing apparatus according to an embodiment of the present invention;

FIG. 3 is a circuit diagram of the touch sensing apparatus according to an embodiment of the present invention;

FIG. 4 is a block diagram of a touch sensing apparatus according to an embodiment of the present invention; and

FIG. 5 is a flow chart illustrating a touch sensing method according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

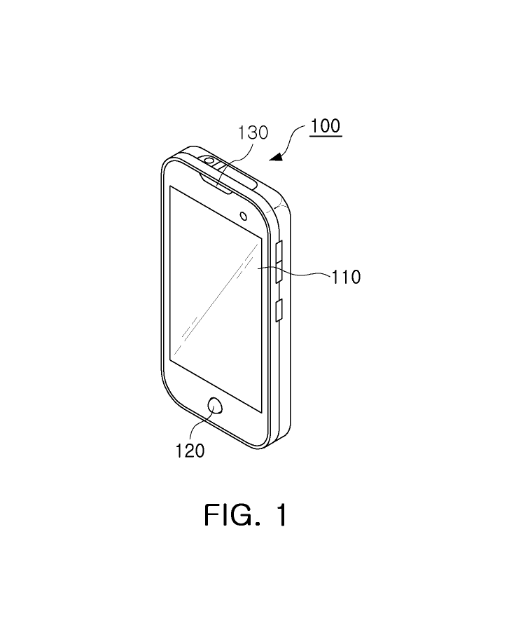

FIG. 1 is a perspective view illustrating the exterior of an electronic device including a touch sensing apparatus according to an embodiment of the present invention.

Referring to FIG. 1, an electronic device 100 according to the present embodiment may include a display unit 110 for outputting a screen, an input unit 120, an audio output unit 130 for outputting audio, and the like, and also, a touch sensing apparatus integrated with the display unit 110.

As illustrated in FIG. 1, in the case of the mobile device, in general, a touch sensing apparatus is integrated with the display unit, and the touch sensing apparatus is required to have sufficient light transmittance to allow an image displayed on the display unit to be transmitted therethrough. Thus, the touch sensing apparatus may be implemented by forming a sensing electrode with a material such as indium tin oxide (ITO), indium zinc oxide (IZO), zinc oxide (ZnO), carbon nanotubes (CNT), or graphene having electrical conductivity on a base substrate made of a transparent film material such as polyethylene terephthalate (PET), polycarbonate (PC), polyethersulfone (PES), polyimide (PI), or the like. A wiring pattern connected to the sensing electrode made of a transparent conductive material is disposed in a bezel region of the display unit, and since the wiring pattern is visually shielded by the bezel region, the wiring pattern may also be made of a metal such as silver (Ag), copper (Cu), or the like.

The input unit 120 may include one or more touch keys provided in a lower portion of the display unit 110, as well as a mechanical key provided in a lateral surface of the electronic device 100. Like a touchscreen provided together with the display unit 110, the touch key may operate according to a capacitive scheme, and a touch sensing apparatus for determining a touch applied to the touchscreen may also determine a touch applied to a touch key.

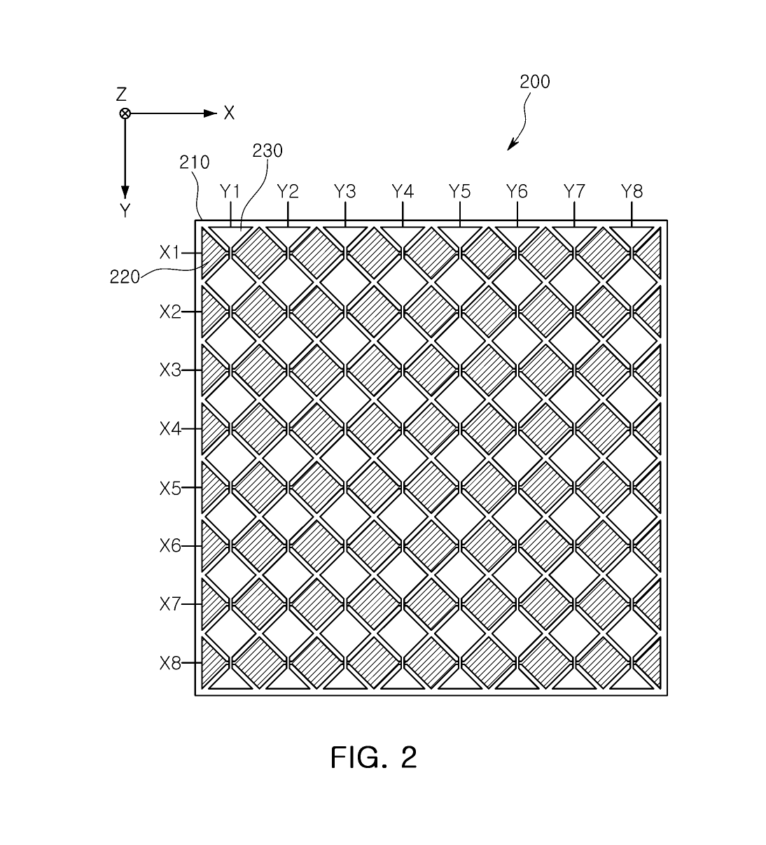

The touch sensing apparatus according to an embodiment of the present invention is supposed to operate according to a capacitive scheme, so it may include a plurality of electrodes having a predetermined pattern. Also, the touch sensing apparatus according to an embodiment of the present invention may include a capacitance sensing circuit detecting a change in capacitance generated by a plurality of electrodes, an analog-to-digital conversion circuit converting an output signal from the capacitance sensing circuit into a digital value, a calculation circuit determining a touch by using data which has been converted into the digital value, and the like. Hereinafter, the touch sensing apparatus according to an embodiment of the present invention will be described with reference to FIGS. 2 through 5.

FIG. 2 is a view illustrating a touchscreen panel unit that may be included in the touch sensing apparatus according to an embodiment of the present invention.

Referring to FIG. 2, a touchscreen 200 according to the present embodiment includes a substrate 210 and a plurality of sensing electrodes 220 and 230 provided on the substrate 210. Although not shown, the plurality of sensing electrodes 220 and 230 may be electrically connected to a wiring pattern of a circuit board attached to one end of the substrate 210 through a wiring and a bonding pad, respectively. A controller integrated circuit (IC) may be mounted on the circuit board to detect sensing signals generated by the plurality of sensing electrodes 220 and 230 and determine a touch from the sensing signals.

In the case of the touchscreen device, the substrate 210 may be a transparent substrate on which the sensing electrodes 220 and 230 are formed, and may be made of a plastic material such as polyimide (PI), polymethylmethacrylate (PMMA), polyethyleneterephthalate (PET), or polycarbonate (PC), or tempered glass. Besides a region in which the sensing electrodes 220 and 230 are formed, a predetermined printed region for visually shielding a wiring generally made of an opaque metal may be formed on the substrate 210 with respect to a region in which the wiring connected to the sensing electrodes 220 and 230 is provided.

The plurality of sensing electrodes 220 and 230 may be formed on one surface of the substrate 210 or on both surfaces thereof. The touchscreen device may be made of ITO, IZO, ZnO, CNT, a graphene material, or the like, which has transparency and conductivity. In FIG. 2, the sensing electrodes 220 and 230 having a diamond-like pattern are illustrated, but the present invention is not limited thereto and the sensing electrodes 220 and 230 may also have various polygonal patterns such as a rectangular pattern, a triangular pattern, or the like.

The plurality of sensing electrodes 220 and 230 include first electrodes 220 extending in an X-axial direction and second electrodes 230 extending in a Y-axial direction. The first electrodes 220 and the second electrodes 230 may be formed on both surfaces of the substrate 210 or may be alternately formed on mutually different substrates 210. In the case in which both the first electrodes 220 and the second electrodes 230 are formed on one surface of the substrate 210, a predetermined insulating layer may be partially formed in intersections between the first electrodes 220 and the second electrodes 230.

The touch sensing apparatus, electrically connected to the plurality of sensing electrodes 220 and 230 to sense a touch, may detect a change in capacitance generated from the plurality of sensing electrodes 220 and 230 according to a touch applied thereto, and sense the touch based on the detected change in capacitance. The first electrodes 220 may be connected to channels defined as D1 to D8 in the control IC to receive a predetermined driving signal, and the second electrode 230 may be connected to channels defined as S1 to S8 so as to be used for the touch sensing apparatus to detect a sensing signal. Here, the controller IC may detect a change in mutual capacitance generated between the first electrodes 220 and the second electrodes 230, as a sensing signal, and operate to sequentially apply a driving signal to the respective first electrodes 220 and simultaneously detect a change in the capacitance in the second electrodes 230. Namely, when M number of first electrodes 220 and N number of second electrodes 230 are provided, the controller IC may detect M×N number of capacitance change data for determining a touch.

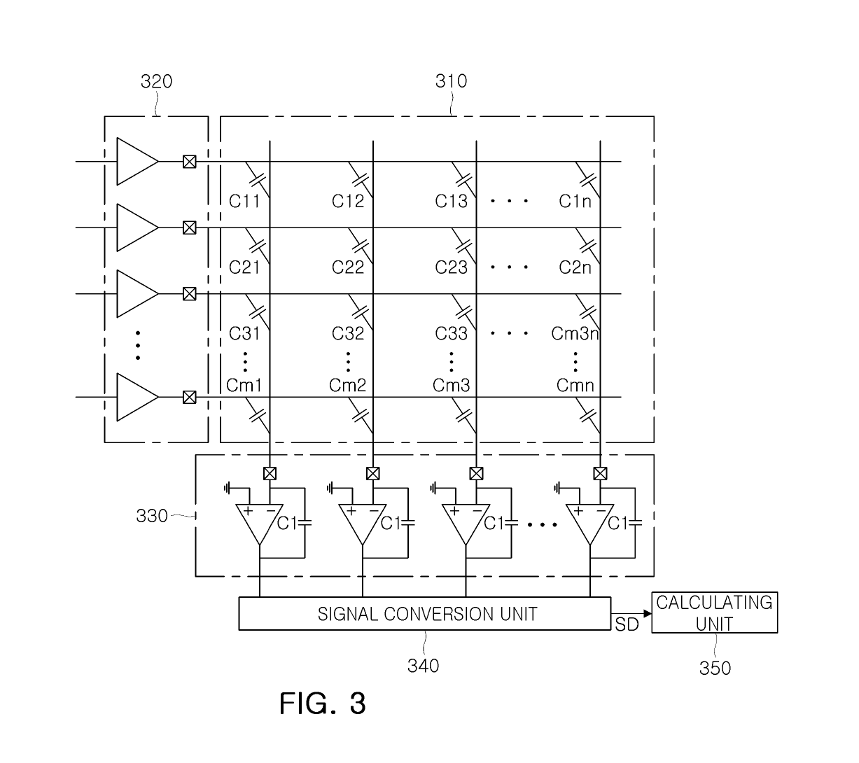

FIG. 3 is a circuit diagram of the touch sensing apparatus according to an embodiment of the present invention.

Referring to FIG. 3, the touch sensing apparatus according to an embodiment of the present invention includes a panel unit 310, a driving circuit unit 320, a sensing circuit unit 330, a signal conversion unit 340, and a calculating unit 350. The panel unit 310 includes m number of first electrodes extending in a first axial direction (or a horizontal direction in FIG. 3) and n number of second electrodes extending in a second axial direction (or a vertical direction in FIG. 3) crossing the first axis. Capacitance changes C11 to Cmn are generated in a plurality of nodes at which the first electrodes and the second electrodes intersect. The capacitance changes C11 to Cmn generated in the plurality of nodes may be changes in mutual capacitance generated by a driving signal applied to the first electrodes by the driving circuit unit 320. Meanwhile, the driving circuit unit 320, the sensing circuit unit 330, the signal conversion unit 340, and the calculating unit 350 may be implemented as a single integrated circuit (IC).

The driving circuit unit 320 applies a predetermined driving signal to the first electrodes. The driving signal may have a square wave form, a sine wave form, a triangle wave form, or the like, having a predetermined period and amplitude, and may be sequentially applied to the plurality of respective first electrodes. In FIG. 3, circuits for generating and applying driving signals are individually connected to the plurality of respective first electrodes, but the present invention is not limited thereto and it may be configured such that a single driving signal generation circuit is provided and a driving signal may be applied to a plurality of respective first electrodes by using a switching circuit. Also, the driving signal may be simultaneously applied to all the first electrodes or may only be selectively applied to a portion of the first electrodes to simply detect the presence or absence of a touch.

The sensing circuit unit 330 may include an integrating circuit for sensing the capacitance changes C11 to Cmn generated in the plurality of nodes. The integrating circuit may be connected to the plurality of second electrodes. The integrating circuit may include at least one operational amplifier and a capacitor C1 having a certain capacity. An inverting input terminal of the operational amplifier is connected to the second electrode to convert capacitance changes C11 to Cmn into an analog signal such as a voltage signal, or the like, and output the same. When driving signals are sequentially applied to the plurality of respective first electrodes, capacitance changes may be simultaneously detected from the plurality of second electrodes, so n number of integrating circuits corresponding to the second electrodes may be provided.

The signal conversion unit 340 generates a digital signal SD from the analog signal generated by the integrating circuit. For example, the signal conversion unit 340 may include a time-to-digital converter (TDC) circuit measuring a time taken for an analog signal in a voltage form output by the sensing circuit unit 330 to reach a predetermined reference voltage level and converting the same into a digital signal SD, or may include an analog-to-digital converter (ADC) circuit measuring an amount by which a level of an analog signal output by the sensing circuit unit 330 changes for a predetermined time and converting the same into a digital signal SD. The calculating unit 350 may determine a touch applied to the panel unit 310 by using the digital signal SD. In an embodiment of the present invention, the calculating unit 350 may determine a number of touches applied to the panel unit 310, coordinates of a touch, a gesture, or the like.

The digital signal SD used as a reference for the calculating unit 350 to determine a touch may be data obtained by digitizing the capacitance changes C11 to Cmn, and in particular, it may be data indicating a difference in capacitance between a case in which a touch has not been generated and a case in which a touch has been generated. In general, in a touch sensing apparatus based on a capacitance scheme, a region in which a conductive object is in contact has reduced capacitance relative to a region in which a touch has not been applied.

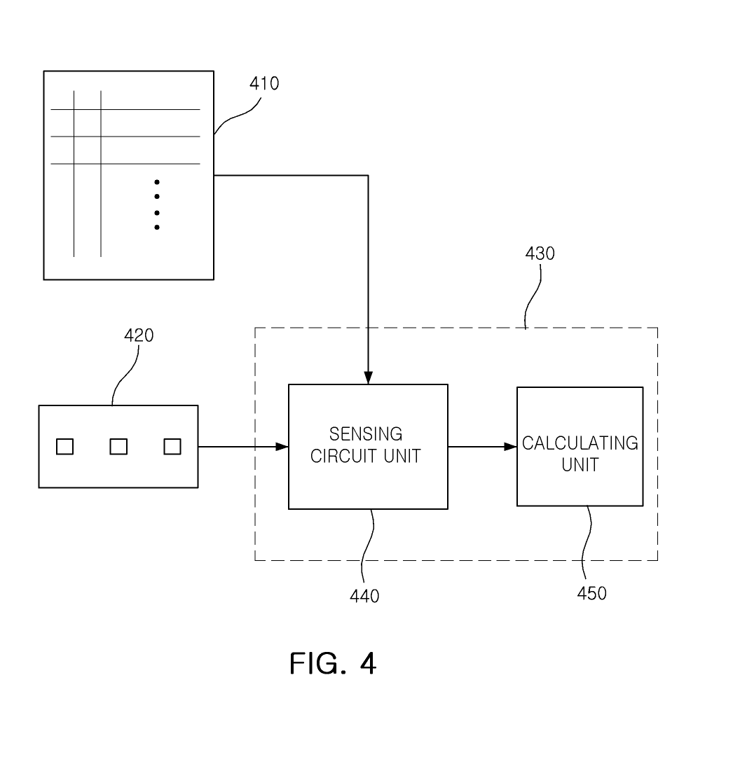

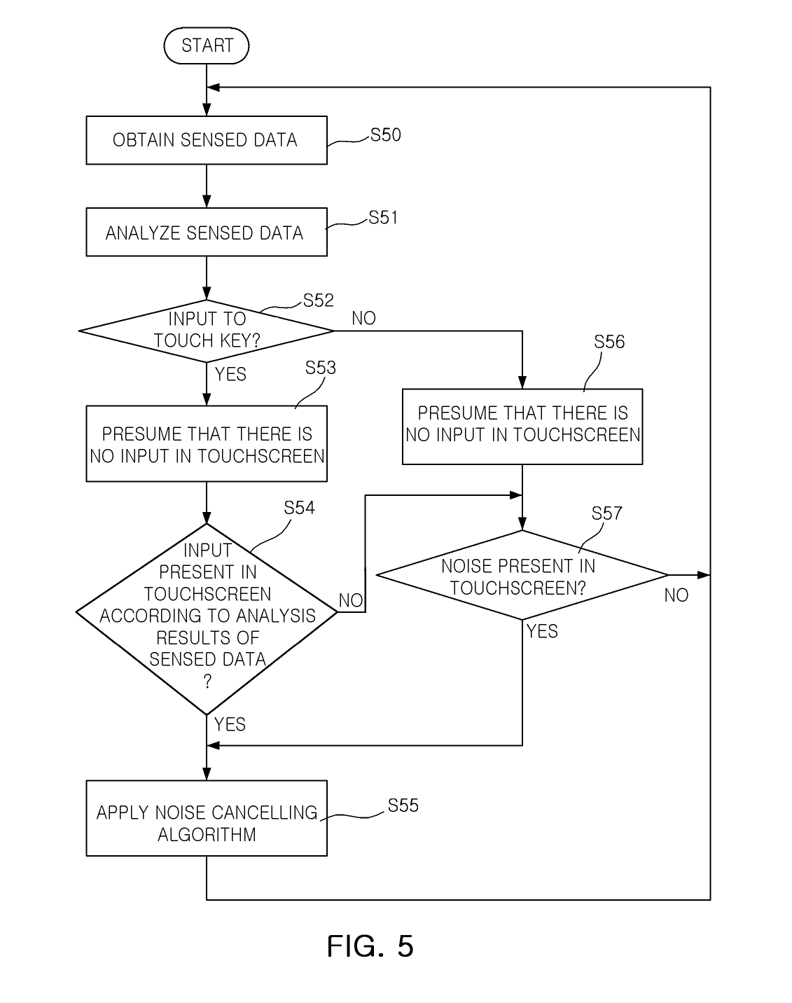

Meanwhile, in an embodiment of the present invention, the calculating unit 350 may determine an input applied to a touch key provided separately from the touchscreen upon detecting a change in capacitance generated in the touch key, as well as determining an input to the touchscreen upon detecting a change in capacitance generated in the panel unit 310. Also, the calculating unit 350 may discriminate a case in which an input generated by the touch key from an otherwise case and determine whether to apply a noise canceling algorithm. This will be described with reference to FIGS. 4 and 5, hereinafter.

FIG. 4 is a block diagram of a touch sensing apparatus according to an embodiment of the present invention.

Referring to FIG. 4, the touch sensing apparatus according to the present embodiment may include a touchscreen 410 including a plurality of electrodes, a touch key 420 having one or more electrodes operating as keys distinguishing the presence or absence of an input, and a controller 430. A plurality of electrodes included in the touchscreen 410 may have a structure similar to that of the panel unit 310 of FIG. 2 or FIG. 3. Also, although not shown in FIG. 4, the controller may further include a driving circuit unit for sensing a touch applied to the touchscreen 410 according to a mutual-capacitance scheme, a signal conversion unit for converting an analog signal output from the sensing circuit unit 440 into a digital signal, and the like.

The touch key 420 includes an electrode corresponding to a number of keys actually provided to the user. Similar to the operational principle of the touchscreen 410, the sensing circuit unit 440 generates a change in capacitance for determining whether a user's touch has been applied to the respective electrodes included in the touch key 420, and the calculating unit 450 may analyze the change in the capacitance to recognize a key to which an input has actually been applied, among one or more keys.

When the sensing circuit unit 440 obtains sensed data from the touchscreen 410 and the touch key 420, first, the calculating unit 450 analyzes the sensed data to determine whether a touch has been applied to the touch key 420. Unlike the touchscreen 410, able to calculate coordinates with a high degree of resolution, the touch key 420 may only need to simply determine the presence or absence of a touch generation, and since the touch key 420 is less affected by electrical noise than the touchscreen 410, the calculating unit 450 first determines whether a touch has been applied to the touch key 420.

When it is determined that a touch has been applied to the touch key 420, the calculating unit 450 presumes that a touch has not been applied to the touchscreen 410. This is merely a conclusion obtained based on the touch applied to the touch key 420, rather than a conclusion actually obtained by using sensed data obtained from the touchscreen 410. Namely, in a general usage environment, a case in which the user simultaneously touches the touchscreen 410 and the touch key 420 is extremely rare or may happen by mistake in most cases, so, when an input is applied to the touch key 420, it is presumed that there is no input in the touchscreen 410.

Based on such presumption, the calculating unit 450 analyzes sensed data obtained from the touchscreen 410. According to analysis results, in a case in which sensed data similar to that of the presence of a touch is obtained, the calculating unit 450 determines that the sensed data has been obtained due to noise introduced to the touchscreen 410, and applies a noise canceling algorithm. Namely, the presence of a touch in the touchscreen 410 according to a user intention in a situation that a touch is already present in the touch key 420 is extremely low, so the calculating unit 450 determines that sensed data obtained from the touchscreen 410 was generated simply due to noise.

The noise canceling algorithm may include at least one of a noise avoidance algorithm, a reference sensed data resetting algorithm, a touchscreen recalibration algorithm, an algorithm for altering driving signal characteristics with respect to a plurality of electrodes, and a sensed data filtering algorithm. Simply, a filtering algorithm may be applied or a voltage level and a frequency of a driving signal applied to a plurality of electrodes may be changed. Alternatively, a reference value of sensed data applied in the calculating unit 450 may be reset.

Meanwhile, when it is determined that a touch has not been applied to the touch key 420 according to the analysis results of the sensed data, the calculating unit 450 may evaluate noise components of respective sensing channels of the touchscreen 410, and apply the noise canceling algorithm according to the evaluation results. Also, in a case in which there is a touch to the touch key 420 and sensed data having a value as high as that of a case in which there is a touch in the touchscreen 410 is not obtained, the calculating unit 420 may evaluate noise components of respective sensing channels of the touchscreen 410 and apply the noise canceling algorithm. This will be described in detail with reference to FIG. 5, hereinafter.

FIG. 5 is a flow chart illustrating a touch sensing method according to an embodiment of the present invention.

Referring to FIG. 5, a touch sensing method according to the present invention starts with the sensing circuit unit 440 obtaining sensed data from the touchscreen 410 and the touch key 420 (S50) and analyzing the obtained sensed data (S51). When the obtaining and analyzing of the sensed data are completed, the calculating unit 450 determines whether there is a touch in the touch key 420 (S52).

When there is a touch in the touch key 420 according to determination results in operation S52, the calculating unit 450 presumes that there is no input in the touchscreen 410 (S53) and determines whether there is touch in the touchscreen 410 based on the results from operation S51 (S54). The presumption that there is no touch in the touchscreen 410 in operation S53 is a simple assumption (or estimation) not based on analysis results of actually obtained sensed data, and the calculating unit 450 determines whether there is an input in the touchscreen 410 by utilizing the sensed data obtained from operation S54.

When it is determined that there is a touch in the touchscreen 410 according to the determination results in operation S54, the calculating unit 450 determines that the sensed data obtained from the touchscreen 410 in operation S50 was generated due to noise and applies the noise canceling algorithm to the touchscreen 510 (S55). As discussed above, the noise canceling algorithm may include at least one of a noise avoidance algorithm, a reference sensed data resetting algorithm, a touchscreen recalibration algorithm, an algorithm for altering driving signal characteristics with respect to a plurality of electrodes, and a sensed data filtering algorithm.

Meanwhile, when it is determined that there is no input in the touchscreen 410 according to the determination results in operation S54, it corresponds to a case in which noise strong enough to affect the entire touchscreen 410 has not been introduced. Thus, the calculating unit 450 may separately determine whether there is noise strong enough for the noise canceling algorithm to be applied to the touchscreen 410 (S57), and apply the noise canceling algorithm according to the determination (S55).

Meanwhile, when it is determined that there is no input in the touch key 420, the calculating unit 450 evaluates a noise component of each sensing channel of the touchscreen 410 (S56). Since there is no touch input in the touch key 420, it may be assumed that sensed data obtained from the touchscreen 410 may have been generated according to a touch applied to the touchscreen 410, and in order to determine whether to cancel noise included in the sensed data separately, a noise component of each sensing channel of the touchscreen 410 is evaluated.

The calculating unit 450 determines whether there is a noise component in the touchscreen 410 based on the evaluation results (S57). When there is a noise component in the touchscreen 410, the calculating unit applies a noise canceling algorithm (S55). If there is no noise component in the touchscreen 410, the calculating unit 450 may obtain sensed data from the touchscreen 410 and the touch key 420 to determine a touch.

As set forth above, according to embodiments of the invention, sensed data obtained from a touch key is analyzed, and when it is determined that a touch has been generated in the touch key, first, it is presumed that there is no touch applied to the touchscreen. Sensed data obtained from the touchscreen is analyzed, and it is determined that a touch has been generated in the touchscreen, the touch is determined as sensed data generated by noise and one or more noise canceling algorithms are applied, whereby whether to apply a noise canceling algorithm can be accurately determined.

While the present invention has been shown and described in connection with the embodiments, it will be apparent to those skilled in the art that modifications and variations can be made without departing from the spirit and scope of the invention as defined by the appended claims.

What is claimed is:

1. A touch sensing method comprising:
obtaining sensed data from a touchscreen and a touch key;
determining whether a touch has been applied to the touch key; and
when it is determined that a touch has been applied to the touch key, whether to apply one or more noise canceling algorithms is determined based on the sensed data obtained from the touchscreen.

2. The touch sensing method of claim 1, further comprising: when it is determined that a touch input has been applied to the touch key, presuming that a touch input has not been applied to the touchscreen.

3. The touch sensing method of claim 1, wherein in the determining whether to apply one or more algorithms, when it is determined that touches have been applied to both the touch key and the touchscreen, the one or more noise canceling algorithms are applied.

4. The touch sensing method of claim 1, wherein in the determining whether to apply one or more algorithms, when it is presumed that a touch has only been applied to the touchscreen, the one or more noise canceling algorithms are applied based on noise included in sensed data obtained from the touchscreen.

5. The touch sensing method of claim 1, wherein in the determining whether to apply one or more algorithms, when it is determined that a touch has only been applied to the touch key, noise of each sensing channel of the touchscreen is evaluated and the one or more noise canceling algorithms are applied.

6. The touch sensing method of claim 1, wherein in the determining whether to apply one or more algorithms, at least one of a noise avoidance algorithm, a reference sensed data resetting algorithm, a touchscreen recalibration algorithm, an algorithm for altering driving signal characteristics with respect to a plurality of electrodes, and a sensed data filtering algorithm is applied as the one or more noise canceling algorithms.

7. A touch sensing apparatus comprising:
one or more touch keys; a touchscreen including a plurality of electrodes; and
a controller obtaining sensed data from the one or more touch keys and the touchscreen and determining a touch,
wherein one or more noise canceling algorithms are applied based on whether a touch has been applied to the one or more touch keys and sensed data obtained from the touchscreen.

8. The touch sensing apparatus of claim 7, wherein when it is determined that a touch has been applied to the one or more touch keys, it is presumed that a touch has not been applied to the touchscreen.

9. The touch sensing apparatus of claim 7, wherein when it is determined that touches have been applied to both the one or more touch keys and the touchscreen, the controller applies the one or more noise canceling algorithms.

10. The touch sensing apparatus of claim 7, wherein when it is determined that a touch has been applied to only the one or more touch keys, the controller evaluates noise of each of a plurality of sensing channels connected to the plurality of electrodes, respectively, and applies the one or more noise canceling algorithms.

11. The touch sensing apparatus of claim 7, wherein when it is determined that a touch has only been applied to the touchscreen, the controller applies the one or more noise canceling algorithms based on noise included in sensed data obtained from the touchscreen.

12. The touch sensing apparatus of claim 7, wherein the one or more noise canceling algorithms include at least one of a noise avoidance algorithm, a reference sensed data resetting algorithm, a touchscreen recalibration algorithm, an algorithm for altering driving signal characteristics with respect to a plurality of electrodes, and a sensed data filtering algorithm.

13. A touch sensing apparatus comprising:
a sensing circuit unit obtaining sensed data from a touch key and a touchscreen; and
a calculating unit determining a touch based on the sensed data,
wherein when it is determined that a touch has been applied to the touch key, the calculating unit presumes that a touch input has not been applied to the touchscreen, and determines whether to apply one or more noise canceling algorithms based on the obtained sensed data.

14. The touch sensing apparatus of claim 13, wherein when it is determined that a touch has been applied to the touchscreen based on sensed data obtained from the touchscreen, the calculating unit applies the one or more noise canceling algorithms.

15. The touch sensing apparatus of claim 13, wherein when it is determined that a touch has not been applied to the touchscreen based on sensed data obtained from the touchscreen, the calculating unit determines whether to apply the one or more noise canceling algorithms based on a noise component included in the sensed data obtained from the touchscreen.

16. The touch sensing apparatus of claim 13, wherein when it is determined that a touch has not been applied to the touch key, the calculating unit determines whether to apply the one or more noise canceling algorithms based on a noise component included in the sensed data obtained from the touchscreen.
